(19) United States
(12) Patent Application Publication
(10) Pub. No.: US 2015/0306898 A1
(43) Pub. Date: Oct. 29, 2015

(54) Retention Clasp

(71) Applicant: Billy Lane Joyner, Dacula, GA (US)

(72) Inventor: Billy Lane Joyner, Dacula, GA (US)

(21) Appl. No.: 14/262,731

(22) Filed: Apr. 26, 2014

(51) Int. Cl. B42F 1/02

(52) U.S. Cl. CPC B42F 1/02

(57) ABSTRACT

A retention clasp comprising a unique, securing mechanism element of a one piece, semi-rigid body for which the securing mechanism element includes two opposing, co-acting, and resilient member segments for holding several sheets of paper or the like together (hereafter “structure-to-be-secured”); wherein each member segment engages portions of structure-to-be-secured on opposite sides in a jaw-like manner to thereby prevent or hinder the movement of structure-to-be secured relative to the surfaces in at least one direction, prevent or hinder the separation of distinct portions of the structure-to-be-secured from each other, or perform a securement of structure-to-be-secured by over-edge engagement thereof; wherein each member segment has an unobstructed, continuous, flat outer surface; and wherein the member segments can be easily moved into and out of engagement with the structure-to-be-secured by direct manual, hand actuated force.

### CROSS-REFERENCE TO RELATED APPLICATIONS

Not Applicable.

### STATEMENT REGARDING FEDERALLY SPONSORED RESEARCH OR DEVELOPMENT

Not Applicable.

### NAMES OF PARTIES TO A JOINT RESEARCH AGREEMENT

Not Applicable.

### REFERENCE TO SEQUENCE LISTING, A TABLE, OR A COMPUTER PROGRAM LISTING COMPACT DISC APPENDIX

Not Applicable.

### STATEMENT REGARDING PRIOR DISCLOSURES BY THE INVENTOR

No prior, public disclosures regarding the present invention have been made by the inventor.

### BACKGROUND OF THE INVENTION

The present invention relates, in general, to retention devices for use in temporarily and securely holding several sheets of loose paper or the like together or other structure-to-be-secured.

In prior art, a wide variety of devices have been devised and used for holding several sheets of loose paper or the like together. Common devices include the Gem Clip or as sometimes may be referred to as a paper clip, spring clips with protruding ear-like projections that require a tool to install them, and spring clips with wire operating handles commonly referred to as binder clips. Each of these devices has inherent, limiting problems associated with their construction or use.

Gem Clips, while they have proven useful for securing a relatively few sheets of loose paper, these clips provide only limited gripping force, they often disengage when turning pages of a document, they get entangled with other clips during storage, they damage paper with their sharp wire ends, and they cannot secure several sheets of paper without structural deformation. The spring clips with protruding ears, while providing a greater gripping force than Gem Clips, can only hold a relatively few sheets of loose paper, are limited in size by their corresponding dispenser, and cannot be installed effectively without a tool.

The binder clip in various sizes has been perhaps the most commonly used device for temporarily securing several sheets of loose paper. The binder clip is substantially a triangular resilient metal spring clip having a back portion and two sides converging therefrom to a common line, together with operating handles, generally made from wire or the like, secured to the sides to operate in connection with the back or the edges joining the back and the sides to spread the sides at the point where they converge against the tension of the metal of which the clips are made. Unfortunately, some individuals including, children, the elderly, and other people with weak or arthritic fingers have difficulty squeezing the wire operating handles. The wire operating handles also obstruct the view of portions of a document, are required to open or close the clip, and obstruct the surfaces of the clip limiting its utilization in other applications.

### BRIEF SUMMARY OF THE INVENTION

In view of the foregoing disadvantages inherent in the known types of retention devices used for holding several sheets of paper or the like together (hereafter “structure-to-be-secured”) that are present in prior art, the present invention provides a new and improved retention clasp to overcome these disadvantages and other problems encountered.

The primary object of the present invention is to provide an economical, one-piece, resilient retention clasp for securely holding structure-to-be-secured, by opposing integral jaws that can be easily engaged or disengaged by manual, hand actuated force without the need for tools or actuation by attached operators.

A second object is to provide a retention clasp that can be easily slid onto or pulled off of structure-to-be-secured, will not get entangled with other clasps while in storage, and will not damage the structure-to-be-secured.

A third object is to provide a retention clasp with unobstructed, flat sides to facilitate corporate branding and other ornamental designs.

A fourth object is to provide a retention clasp with an unobstructed back and sides to facilitate mounting the clasp to other objects or incorporating the clasp into other designs and inventions in varied configurations wherein, with minor modification, the retention clasp's position is fixed and the structure-to-be-secured can be easily inserted into or pulled out of engagement with the retention clasp without the need for operating handles or tools.

Other objects, features, and attendant advantages of the present invention will become more apparent from the Detailed Description of the Invention in conjunction with the accompanying drawings and it is intended herein that those objects, features, and attendant advantages are part of the scope of the current invention.

To the accomplishment of the aforementioned objects and other related objects, features, and attendant advantages, this invention may be embodied in the form illustrated in the accompanying drawings, attention being called to the fact, that the drawings are for illustration purpose only and that the present invention is not limited thereto.

### BRIEF DESCRIPTION OF THE SEVERAL VIEWS OF THE DRAWING

The accompanying drawings, which are incorporated in and constitute a part of this specification, illustrate certain aspects of the present disclosure and together with the Detailed Description of the Invention, serve to explain, without limitation, the principles of the invention. The preferred embodiments of the invention are provided for illustration only and shall not limit the invention, wherein like designations denote substantially equivalent elements of the invention or details to which they refer, and wherein:

FIG. 1 illustrates a perspective view of a preferred embodiment for the present invention.

FIG. 2 illustrates a side view of a preferred embodiment for the present invention.

FIG. 3 illustrates a side view of a preferred embodiment for the present invention and structure-to-be-secured, prior to engagement.

FIG. 4 illustrates a side view of a preferred embodiment for the present invention engaged with structure-to-be-secured.

FIG. 5 illustrates a preferred embodiment for the present invention securely holding several sheets of loose paper, or the like, together.

FIG. 6 illustrates a second embodiment for the present invention holding several sheets of loose paper, or the like, together.

FIG. 7 illustrates a third embodiment for the present invention made from a rubber (natural or synthetic) material, a plastic material, a nylon material, or the like.

FIG. 8 illustrates a fourth embodiment of the present invention with minor modification to incorporate a positive securing component to the invention.

### DETAILED DESCRIPTION OF THE INVENTION

The following detailed description of the invention refers to the accompanying drawings, wherein the cited reference characters identify the same or substantially equivalent elements of the invention or details to which they refer. It is to be understood that the following description and the accompanying drawings are provided for illustration only and do not limit the invention. Instead, the scope of the invention is defined by the appended claims and equivalents thereof.

The present invention solves the inherent problems of related prior art by providing a retention clasp comprising a unique, securing mechanism element of a one piece, semi-rigid body for which the securing mechanism element includes two opposing, co-acting, and resilient member segments; wherein each member segment engages several sheets of loose paper or the like together (hereafter “structure-to-be-secured”) on opposite sides in a jaw-like manner to thereby prevent or hinder the movement of structure-to-be secured relative to the surfaces in at least one direction, prevent or hinder the separation of distinct portions of the structure-to-be-secured from each other, or perform a securement of structure-to-be-secured by over-edge engagement thereof; wherein each member segment has an unobstructed, continuous, flat outer surface; and wherein the member segments can be easily moved into and out of engagement with the structure-to-be-secured by direct manual, hand actuated force and thereby eliminate the need for tool force thereon or actuation by an attached operator.

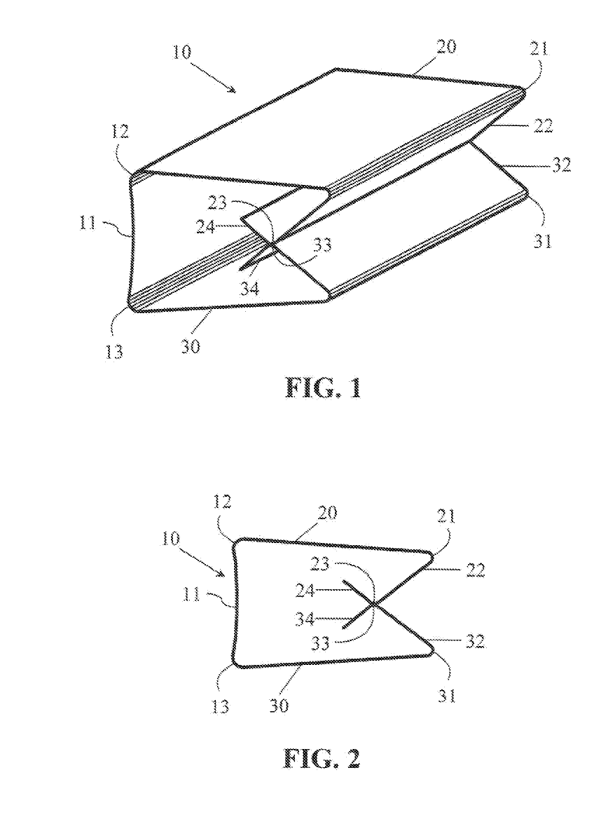

Referring specifically to the drawings, preferred embodiments of the retention clasp are provided in FIGS. 1-8 and is shown as reference numeral 10. The retention clasp 10 may be formed from numerous resilient materials that permit repeated engagement and disengagement with a predetermined thickness of structure-to-be-secured without deformation of the retention clasp 10. Such resilient materials may include, for example, a rubber (natural or synthetic) material, a plastic material, a nylon material, or a metal material each having natural or induced spring-like characteristics.

FIG. 1 illustrates a perspective view and FIG. 2 illustrates a side view of a preferred embodiment for the retention clasp 10 which for this embodiment is made by bending a rectangular, thin strip of metal at various points along and perpendicular to its longitudinal length. Relative to the maximum thickness of structure-to-be-secured, the rear supporting portion (“back”) 11 of the retention clasp 10 is formed by bending the metal strip an equal distance from its longitudinal center along lines 12 and 13 resulting in a contiguous first member segment 20, a contiguous and opposing second member segment 30, and the spring induced back 11 disposed there between. The metal strip is bent along lines 12 and 13 such that the first member segment 20 and the opposing second member segment 30 extend radially away from the retention clasp back 11 and converge towards each other. The retention clasp back 11 may be convex, flat, or concave depending upon the desired gripping strength, methods of construction, or intended utilization.

The first member segment 20 of the metal strip is then bent along line 21 and the second member segment 30 is bent along line 31 inward towards its opposing member segment and towards the back 11 at acute angles resulting in engagement surfaces 22 and 32 of the retention clasp 10.

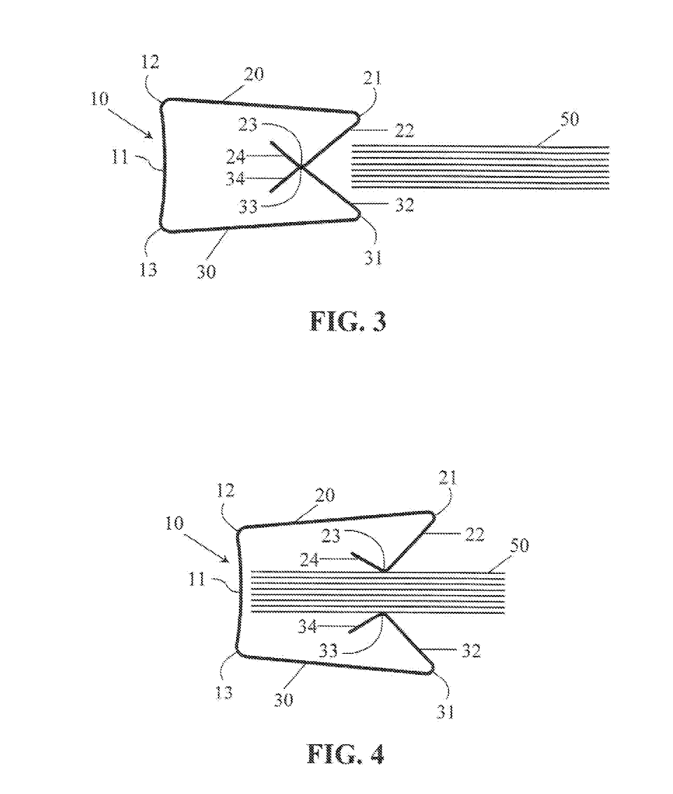

As illustrated in FIG. 3, engagement surfaces 22 and 32 of the retention clasp 10 form a throat for accepting a predetermined maximum thickness of structure-to-be-secured 50. As the retention clasp 10 is engaged with structure-to-be-secured 50, as illustrated in FIG. 4, the opposing member segments 20 and 30 are opened against their designed static bias towards each other by the force applied between structure-to-be-secured 50 and engagement with surfaces 22 and 32.

At or near the resulting point of convergence of the opposing member segments 20 and 30 or their point of contact, by design, with structure-to-be-secured 50, the first member segment 20 of the metal strip is then bent along line 23 and the second member segment 30 is bent along line 33 inward away from the opposing member segment and towards the back 11 to form the gripping surfaces of retention clasp 10 with structure-to-be-secured 50 along lines 23 an 33 and the disengagement surfaces 24 and 34 of the retention clasp 10.

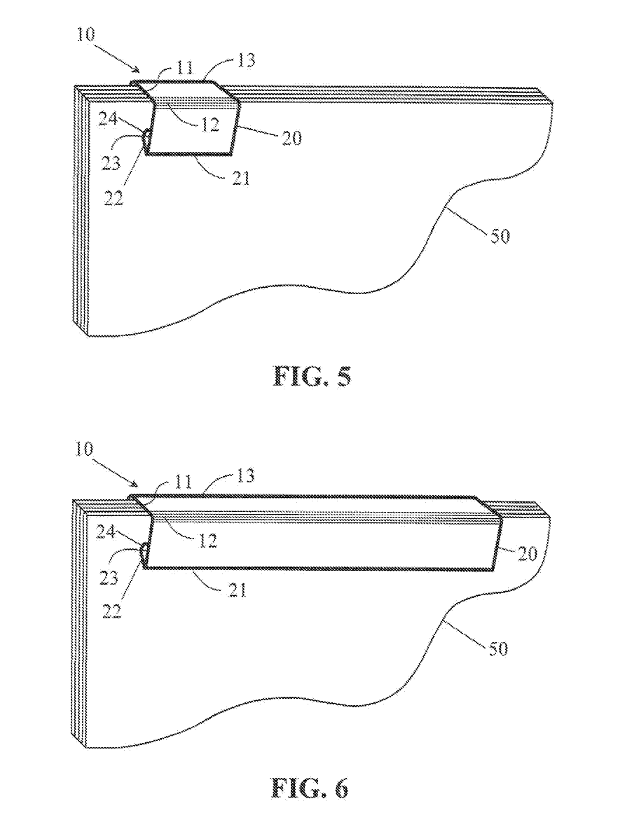

As illustrated in FIG. 5, the retention clasp 10 is shown in application engaging structure-to-be-secured 50 on opposite sides in a jaw-like manner to thereby prevent or hinder the movement of structure-to-be secured 50 relative to the surfaces in at least one direction, preventing or hindering the separation of distinct portions of the structure-to-be-secured 50 from each other, and performing a securement of structure-to-be-secured 50 by over-edge engagement thereof.

As illustrated in FIG. 6, for a second embodiment of the retention clasp 10, various dimensional and configuration modifications may be made, by design, to the retention clasp 10 for desired engagement with structure-to-be secured 50.

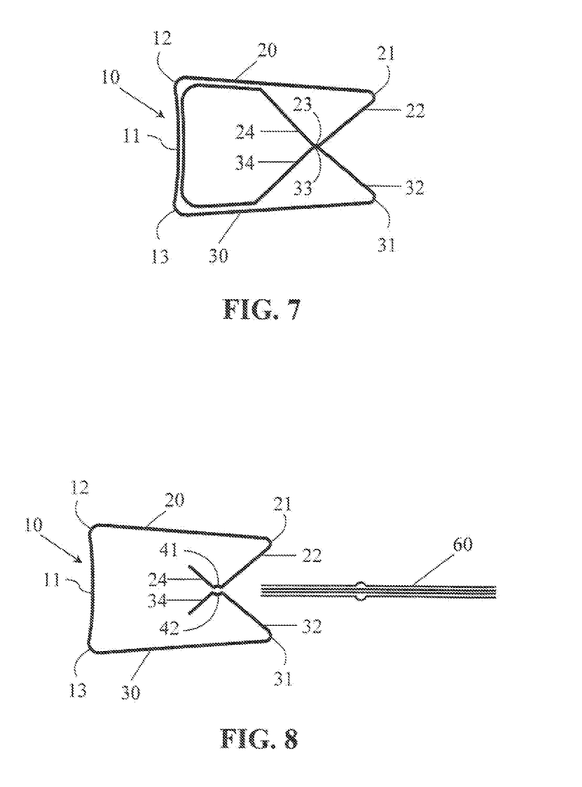

Within the essence of the present invention, the retention clasp 10 may be formed from a rubber (natural or synthetic) material, a plastic material, a nylon material, or the like, as illustrated in FIG. 7 for a third embodiment of the retention clasp 10.

Within the essence of the present invention, the retention clasp 10 may also be adapted to provide a securing component, by design, at the gripping surfaces of the retention clasp 10 for structure-to-be-secured 60 along lines 41 and 42, as illustrated in FIG. 8 for a fourth embodiment of the retention clasp 10.

The foregoing is considered as illustrative only of the principles of the invention. Since numerous modifications and changes will be readily apparent by those skilled in the art, this specification shall not limit the present invention to the exact construction and operation shown and described. Various modifications or changes may be effected in the construction illustrated or within the description of the appended claims without deviating from the essence of the present invention.

With respect to the drawings and Detailed Description of the Invention, the dimensional relationships of the present invention and variations in size, material, shape, form, function, manner of operation, construction, or use shall be deemed readily apparent and obvious to those skilled in the art and all equivalent relationships to those illustrated in the drawings and described in the specification are intended to be encompassed by the present invention. Accordingly, all modifications, equivalents, and substitutions shall be resorted to falling within the scope of the present invention which is limited only by the appended claims and their equivalents.

What I claim is:

1. A retention clasp comprising a unique, securing mechanism element of a one piece, semi-rigid body for which the securing mechanism element includes two opposing, co-acting, and resilient member segments; wherein each member segment engages portions of structure-to-be-secured on opposite sides in a jaw-like manner to thereby prevent or hinder the movement of structure-to-be secured relative to the surfaces in at least one direction, prevent or hinder the separation of distinct portions of the structure-to-be-secured from each other, or perform a securement of structure-to-be-secured by over-edge engagement thereof.

2. A retention clasp as set forth in claim 1 wherein both the redirection of the member segments along their radial lengths so as to form a throat for accepting a predetermined maximum thickness of structure-to-be-secured and the redirection of each member segment's free end at or near the resulting point of convergence of the opposing member segments or their point of contact, by design, with structure-to-be-secured facilitate the ability of the member segments to be easily moved into and out of engagement with the structure-to-be-secured by direct manual, hand actuated force thereon.

3. A retention clasp as set forth in claim 1 wherein each member segment extends away from the body's shared integral rear supporting portion at a predetermined distance apart; wherein each member segment has a free end; wherein, upon a point along the radial length of one member segment, the free end of said member segment is redirected inward towards the opposing member segment and towards the body's rear supporting portion to form an acute angle; wherein, upon a point along the radial length of the second member segment, the free end of said second member segment is redirected inward towards the opposing first member segment and towards the body's rear supporting portion to form an acute angle; wherein, at or near the resulting point of convergence of the opposing member segments or their point of contact, by design, with structure-to-be-secured, the free end of each member segment is redirected inward and away from the opposing member segment; wherein each member segment is resiliently biased in the direction towards the opposing member segment; and wherein the extremities of the member segments are maintained in juxtaposition by the material and/or methods utilized for construction.
